(19) United States
(12) Patent Application Publication
(10) Pub. No.: US 2016/0124289 A1
(43) Pub. Date: May 5, 2016

(54) USER SECURED WRIST STRAP FOR CAMERA

(71) Applicants: Douglas L. James, Phoenix, AZ (US); Michelle L. James, Phoenix, AZ (US)

(72) Inventors: Douglas L. James, Phoenix, AZ (US); Michelle L. James, Phoenix, AZ (US)

(21) Appl. No.: 14/991,783

(22) Filed: Jan. 8, 2016

Related U.S. Application Data
(63) Continuation of application No. 14/298,939, filed on Jun. 8, 2014.

(51) Int. Cl. G03B 17/56; A45F 3/00

(52) U.S. Cl. CPC G03B 17/561; G03B 17/566; A45F 3/00; A45F 2003/006

(57) ABSTRACT

This is a camera strap which encircles the user's wrist in the manner of a cinching-style mechanism which is user adjustable and/or adjusted by the hanging weight of the attached camera. The strap utilizes the two connecting points on either side of the camera body. The cinching wrist strap will attach to those two connecting points via a loop of webbing and retention clips. Quick release buckles allow the user to disconnect and/or interchange straps in a quick manner. This method of attaching the camera to the user's wrist allows ease of use and offers additional security.

### CROSS REFERENCE TO RELATED APPLICATIONS

This application is a continuation and claims the benefit of U.S. patent application Ser. No. 14/298,939 of the same title, filed Jun. 8, 2014, and incorporated fully herein by reference.

### BACKGROUND OF THE INVENTION

Photographic camera straps are traditionally designed to hang the camera equipment around the neck of the user. However, some photographers instead choose to continually hold the camera in their hand.

Current applications of existing wrist or hand straps do not address the problem of tethering the camera securely to the user's wrist in the event of an accidental drop or attempted theft. Most camera straps currently available for the wrist are loose and do not attach snug to the user, nor do other designs attach securely to the camera by utilizing the two standard connecting points.

This design of the wrist strap utilizes both standard attachment points of the camera body and relates to the attachment of the camera to the user's wrist via a cinching manner and thereby creating an extension of the user's arm and additional security.

### BRIEF SUMMARY OF THE INVENTION

The intent of this new wrist strap is to attach the camera to the user's wrist allowing ease of use and additional security. This embodiment of the wrist strap will encircle the user's wrist in the manner of a cinching-style mechanism and attach to a typical camera in a standard method by utilizing the two connecting points on either side of the camera body.

The two connecting points of the wrist strap will attach to the camera in the same manner as a standard neck strap. The connecting points on the camera are typically located on the right and left sides of the camera body seated in its normal (horizontal) position. The wrist strap will attach to those two connecting points via a loop of webbing and retention clips. A quick release buckle is also part of this attachment thus allowing the user to disconnect and/or interchange straps in a quick manner.

The wrist strap may include webbing which is arranged and connected via plastic retention clips and machine stitching in a manner that allows the unit to function as a cinching mechanism to the user's wrist. There is a layer of padding and a fabric cover over a portion of the wrist strap to ensure user comfort. The wrist strap is adjustable in length.

### BRIEF DESCRIPTION OF THE DRAWINGS

FIG. 1 is a perspective view of the complete camera wrist strap.

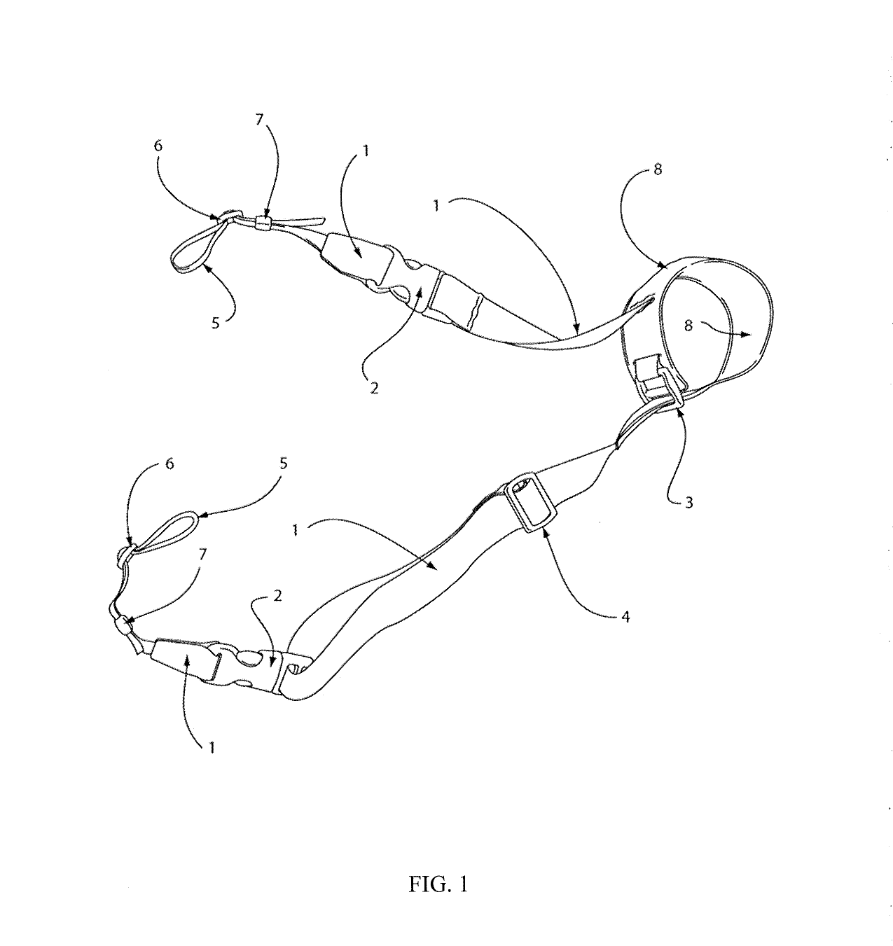

FIG. 2 shows the construction, highlighting the attachment points on the webbing to form the cinching mechanism feature of the wrist strap.

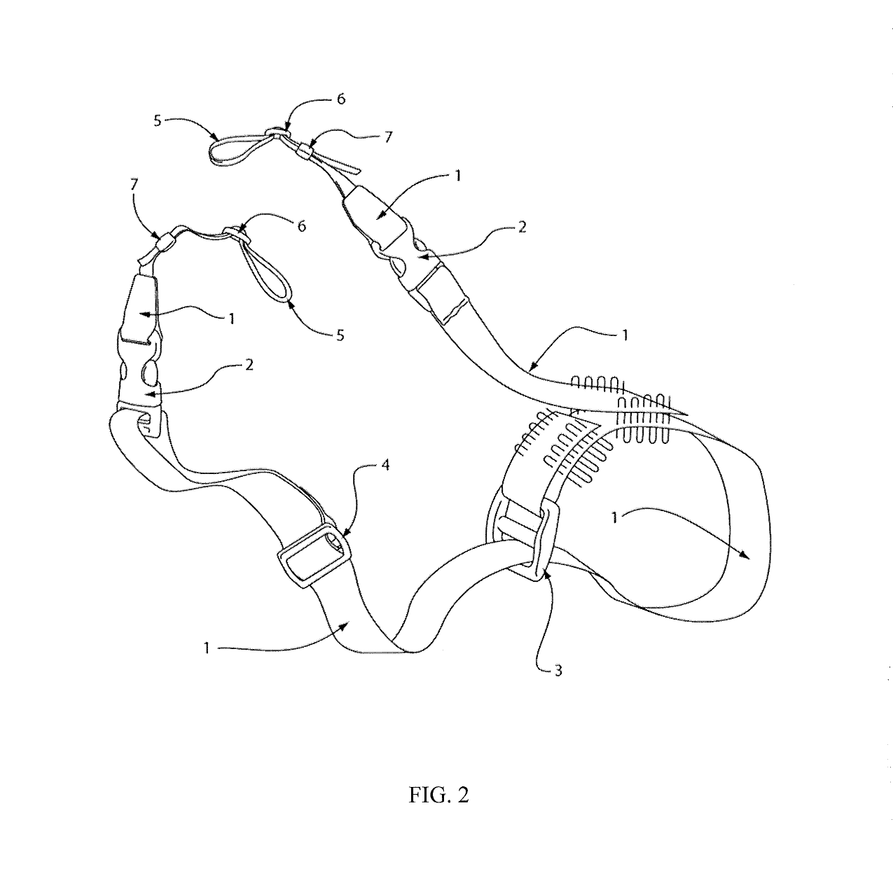

FIG. 3 shows construction of attaching points to the camera.

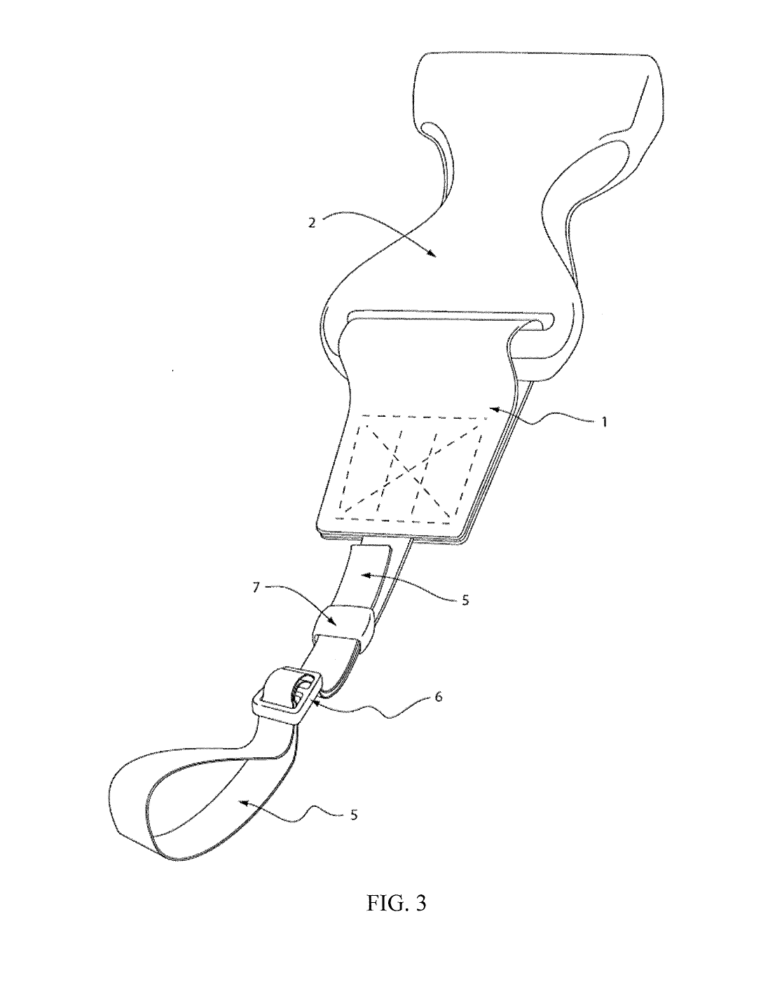

FIG. 4 is an embodiment of the wrist strap as attached to a camera and to the user's wrist.

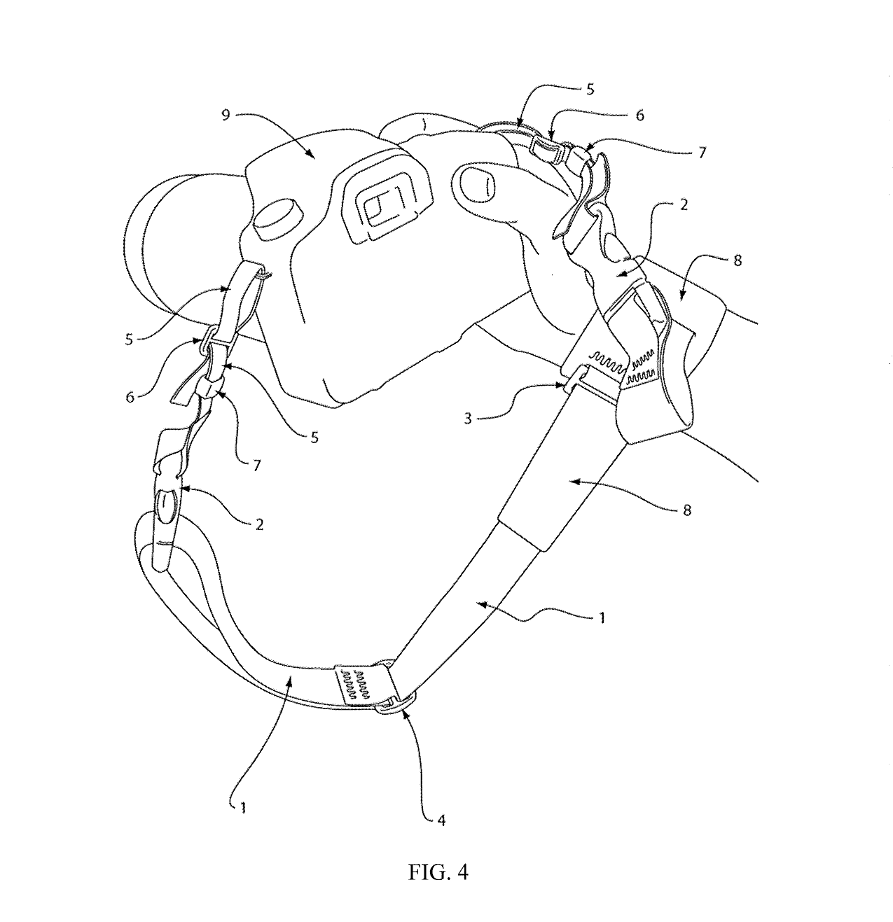

### REFERENCE NUMERALS IN THE DRAWINGS

1 webbing
2 quick release/connect buckle
3 tri-glide buckle (receives width of 1 webbing)
4 tri-glide buckle (receives width+¼″ of 1 webbing)
5 ⅜″ width webbing
6 ⅜″ strap keeper
7 ⅜″ widemouth sliplock
8 padding & material covering
9 camera body

### DETAILED DESCRIPTION OF THE INVENTION

The present invention is designed to support the weight of a typical camera body and lens by securing the camera snugly to the user's wrist.

In the preferred embodiment, the main portion of the wrist strap consists of a length of webbing 1 (e.g. nylon/polyester/cotton) which is cut to a suitable length to accommodate the circumference of a typical wrist measurement with additional length for adjustment. This is fed through an outside rung of a tri-glide buckle 3 that is at least ¼″ wider than the webbing 1, is then folded over and machine stitched in place to secure. The loose end of the webbing is then slipped through the opposite side of the same tri-glide buckle 3 in a manner that allows the unit to function as a cinching mechanism to the user's wrist.

Another tri-glide buckle 4 and quick release/connect buckles 2 which have openings that accept the same width as the webbing are now utilized.

The same unconnected length of webbing 1 is then threaded through (in & out) both sides of another tri-glide buckle 4, then through the male side of a quick release/connect buckle 2, and finally back around the center portion of the tri-glide buckle 4 and folded over and secured to itself with machine stitching. This allows for the length of the cinching portion of the wrist strap to be adjustable.

One end of a separate length of webbing 1 which is the same width of webbing used for the cinching portion of the wrist strap is then machine stitched to the cinching portion of the wrist strap. The location of the attaching point should be just above the fold-over point of the webbing where it is attached to the outer rung of the larger tri-glide buckle 3. The loose end of the webbing is then fed through the male side of a quick release/connect buckle 2, folded over and then machine stitched in place to secure.

The following process is to construct the portions of the strap that connect directly to the camera, and utilize the female side of each quick release/connect buckle 2.

Two pieces of the primary width webbing 1 are cut to an approximate length of 4″. Two pieces of ⅜″ width webbing 5 are cut to an approximate length of 11″. The standard attaching points of a camera body will accept up to ⅜″ material. One of the ⅜″ width webbing 5 pieces is then lined up from one end and down the center length of the wider webbing 1. The two pieces are then machine stitched together. This process is repeated for the remaining two pieces of webbing.

The wider piece of webbing 1, is then fed halfway through the female side of one of the quick release/connect buckles 2. The webbing should have the ⅜″ portion on the interior fold. The wider portion of webbing is then folded over and machine stitched in place to secure. This process is repeated for the remaining female side of the quick release/connect buckle.

The loose end of the ⅜″ webbing 5 is then fed through a ⅜″ strap keeper 6 and then woven through a ⅜″ widemouth sliplock 7. Leaving enough length to form a loop, the webbing is then folded back upon itself and fed back through the ⅜″ widemouth sliplock 7 and strap keeper 6. This process is repeated on the remaining female side of a quick release/connect buckle.

For the comfort of the user, a layer of padding and material 8 is attached to the portion of webbing that is intended to encircle the user's wrist. The tri-glide buckle utilized for the cinching portion of the wrist strap should allow for the easy pass-through of the padding 8.

In use, the camera strap is slipped over the user's hand and cinched snugly to the wrist. The retaining clips of the strap are connected to their companion clips of the shorter straps attached to the camera body. It is the intent that the user will primarily hold the camera body in their hand. The wrist strap provides the user some security from dropping the camera, and may also be used as a mechanism to carry the camera as it is hanging from the wrist.

What is claimed is a device for tethering a camera securely to the user's wrist wherein the invention is comprised of webbing, buckles, and other materials which are arranged into a cinching-style loop that will tighten to the wrist by adjustment of the user and/or by utilizing the hanging weight of the attached camera.

What is claimed is:

1. A device for securing a camera having strap attachment points for a neck strap to a wrist of a user, the device comprising:
a first length of webbing having a first end and a second end;
a first tri-glide buckle being wider than the first length of webbing, the first length of webbing being disposed through the first tri-glide buckle and stitched to itself at the first end to attach the first length of webbing to the first tri-glide buckle, and the second end of the first length of webbing being further disposed through the first tri-glide buckle to form a cinching portion of the first length of webbing, the cinching portion tightening against the wrist utilizing a hanging weight of the camera when the camera is dropped;
a first quick release/connect buckle having a first side and a second side, the first length of webbing attached to the first side of the first quick release/connect buckle;
a first connecting portion attached to the second side of the first quick release/connect buckle and configured to attach to a first attachment point of the strap attachment points;
a second length of webbing having a first end and a second end, the second length of webbing stitched to the first length of webbing at the first end of the second length of webbing;
a second quick release/connect buckle having a first side and a second side, the second length of webbing attached to the first side of the second quick release/connect buckle at the second end of the second length of webbing; and
a second connecting portion attached to the second side of the second quick release/connect buckle and configured to attach to a second attachment point of the strap attachment points.

2. The device of claim 1, wherein the first length of webbing is attached to the first tri-glide buckle at a fold-over point of the first length of webbing and the second length of webbing is attached to the first length of webbing approximate the fold-over point.

3. The device of claim 3, further comprising padding attached to the cinching portion, wherein the first tri-glide buckle allows the padding to pass through the first tri-glide buckle as the loop tightens.

4. The device of claim 1, further comprising a second tri-glide buckle, the first length of webbing being threaded through the second tri-glide buckle, threaded through the first side of the first quick release/connect buckle, and then secured to the second tri-glide buckle to form an adjustable wrist strap.

5. The device of claim 1, wherein the first connecting portion comprises:
a first piece of webbing having the same width as the first length of webbing;
a second piece of webbing having a lesser width than the first piece of webbing, the second piece of webbing attached to the first piece of webbing;
a strap keeper; and
a sliplock;
the second piece of webbing being secured to the first connection point and then being fed through the strap keeper and the sliplock to attach the wrist strap to the camera.

6. A method, comprising:
feeding a first end of a first length of webbing through a first buckle;
attaching the first length of webbing to itself at the first end to attach the first length of webbing to the first buckle at a fold-over point of the first length of webbing;
feeding a second end of the first length of webbing through the first buckle to form a cinching portion in the first length of webbing;
securing the first length of webbing to a first quick release/connect buckle attached to a first connecting portion configured to attach to a first attachment point of a camera;
attaching a second length of webbing to the first length of webbing at a first end of the second length of webbing; and
securing the second length of webbing to a second quick release/connect buckle at a second end of the second length of webbing, the second quick release/connect buckle being attached to a second connecting portion configured to attach to a second attachment point of the camera;
wherein when the first and second connecting portions are attached to the camera, the cinching portion tightens around a wrist of a user of the camera utilizing a hanging weight of the camera.

7. The method of claim 6, wherein securing the first length of webbing to the first quick release/connect buckle comprises:
threading the second end of the first length of webbing through a second buckle;
threading the second end of the first length of webbing through the first quick release/connect buckle; and
securing the first length of webbing to the second buckle at the second end of the first length of webbing to form a wrist strap with an adjustable length.

8. The method of claim 7, wherein securing the first length of webbing to the second buckle comprises:
threading the second end of the first length of webbing around a center portion of the second buckle; and
stitching the first length of webbing to itself at the second end of the first length of webbing.

9. The method of claim 6, wherein stitching the second length of webbing to the first length of webbing at the first end of the second length of webbing comprises stitching the second length of webbing to the cinching portion approximate the fold-over point.

10. The method of claim 6, further comprising attaching padding to the cinching portion, the first buckle allowing for easy pass-through of the padding.

11. The method of claim 6, further comprising:
attaching a first piece of webbing to a second piece of webbing to form the first connecting portion, wherein the second piece of webbing is less wide than the first piece of webbing and is accepted by standard attaching points of the camera, the standard attaching points including the first attachment point and the second attachment point, and wherein, to attach the first connecting portion to the camera, the second piece of webbing is secured to the first connection point and then fed through a first strap keeper and a first sliplock; and
securing the first piece of webbing to the first quick release/connect buckle.

12. The method of claim 11, further comprising:
attaching a third piece of webbing to a fourth piece of webbing to form the second connecting portion, wherein the fourth piece of webbing is less wide than the third piece of webbing and is accepted by the standard attaching points of the camera, and wherein, to attach the second connecting portion to the camera, the fourth piece of webbing is secured to the second connection point and then fed through a second strap keeper and a second sliplock; and
securing the third piece of webbing to the second quick release/connect buckle.

13. A wrist strap comprising:
a main portion having a first end and a second end;
a first connecting portion secured to the main portion and attaching the wrist strap to a first connection point of a camera;
a second connecting portion secured to the main portion and attaching the wrist strap to a second connection point of the camera; and
a first buckle, the main portion attached to and passing through the first buckle to form, between the first end and the second end of the main portion, a cinching loop that tightens to a wrist of a user by both user adjustment and a hanging weight of the camera.

14. The wrist strap of claim 13, wherein the main portion comprises:
a first length of webbing having a first end at the first end of the main portion, and a second end disposed through the first buckle and securing the first buckle to the first length of webbing, the first length of webbing including the cinching loop; and
a second length of webbing having a first end attached to the first length of webbing, and a second end at the second end of the main portion.

15. The wrist strap of claim 14, wherein the first end of the second length of webbing is attached to the cinching loop.

16. The wrist strap of claim 14, wherein the first length of webbing is the same width as the second length of webbing.

17. The wrist strap of claim 13, wherein the first connecting portion comprises:
a first piece of webbing;
a second piece of webbing having a lesser width than the first piece of webbing, the second piece of webbing attached to the first piece of webbing;
a strap keeper; and
a sliplock;
the second piece of webbing being secured to the first connection point and then being fed through the strap keeper and the sliplock to attach the wrist strap to the camera.

18. The wrist strap of claim 17, further comprising a first quick release/connect buckle having a first side and a second side, the first piece of webbing being secured to the first side of the first quick release/connect buckle, and the main portion being secured to the second side of the first quick release/connect buckle.

19. The wrist strap of claim 13, further comprising padding attached to the cinching loop and passing through the first buckle as the cinching loop tightens.

20. The wrist strap of claim 13, further comprising a second buckle, the main portion being disposed through the second buckle, the first end of the main portion securing the main portion to the second buckle such that the wrist strap has an adjustable length.
